(19) United States
(12) Patent Application Publication
(10) Pub. No.: US 2025/0317365 A1
(43) Pub. Date: Oct. 9, 2025

(54) SPLITTING A MACHINE LEARNING INFERENCE PROCESS

(71) Applicant: Telefonaktiebolaget LM Ericsson (publ), Stockholm (SE)

(72) Inventors: Jing YUE, Danderyd (SE); Zhang FU, Stockholm (SE); Maria Belen PANCORBO MARCOS, Madrid (ES); Antonio INIESTA GONZALEZ, Madrid (ES)

(73) Assignee: Telefonaktiebolaget LM Ericsson (publ), Stockholm (SE)

(21) Appl. No.: 18/862,985

(22) PCT Filed: May 3, 2023
(86) PCT No.: PCT/EP2023/061630

§ 371 Date: Nov. 5, 2024

(30) Foreign Application Priority Data
May 6, 2022 (EP) 22382437.6

(51) Int. Cl. H04L 41/16; H04L 41/40

(52) U.S. Cl. CPC H04L 41/16; H04L 41/40

(57) ABSTRACT

A method performed by a user equipment, (UE), is provided. The method comprises transmitting towards an application function, (AF) a request for splitting an ML inference process. The request comprises any one or more of: information about the UE, information about the ML inference process, and/or a request for information about a network to which the UE is connected. The method further comprises after transmitting the request for splitting the ML inference process, receiving split decision information indicating how to split the ML inference process. The split decision information was transmitted by the AF.

### TECHNICAL FIELD

This disclosure relates to methods, apparatus, and/or systems for splitting a machine learning inference process.

### BACKGROUND

Artificial Intelligence (Al)/Machine Learning (ML) is being used in a wide range of application domains across industry sectors. In mobile communications systems, conventional algorithms (e.g., speech recognition, image recognition, video processing) are increasingly replaced by AI/ML models for various applications, as described in Technical Report (TR) 22.874, version 18.2.0. The TR covers use cases and potential requirements for Fifth Generation (5G) system support of AI/ML model distribution and transfer (download, upload, updates, etc.).

In recent years, AI/ML-based mobile applications are increasingly computation-intensive, memory-consuming, and power-consuming. Meanwhile, end devices (e.g., mobile phones, laptops, etc.) usually have stringent energy consumption, computation, and memory cost limitations for running a complete offline AI/ML inference process onboard. Hence, in many AI/ML applications, AI/ML inference process (herein after, “ML inference process”) is offloaded from mobile devices to internet datacenters (IDC). Nowadays, even photos captured by smartphones are often processed in a cloud AI/ML server before the photos are shown to the users of the smartphones.

### SUMMARY

There may be a scenario, however, where it may be better to perform at least a part of an ML inference process at a UE and perform the remaining part of the ML inference process in a cloud/edge server. For example, in case the ML inference process involves a privacy-sensitive process or a delay sensitive-process, it may be better to perform those processes at the UE. On the other hand, in case the ML inference process involves a computation-intensive process or an energy-intensive process, it may be better to perform those processes in the cloud/edge server. Thus, there is a need for an optimal way to determine how to split an ML inference process between UEs and cloud/edge servers.

Accordingly, in one aspect of the embodiments of this disclosure, there is provided a method performed by a user equipment, UE. The method comprises transmitting towards an application function, AF, a request for splitting an ML inference process, wherein the request comprises any one or more of: information about the UE, information about the ML inference process, and a request for information about a network to which the UE is connected. The method further comprises, after transmitting the request for splitting the ML inference process, receiving split decision information indicating how to split the ML inference process, wherein the split decision information was transmitted by the AF.

In another aspect, there is provided a method performed by an application function, AF. The method comprises receiving a request for splitting an ML inference process, wherein the request was transmitted by a user equipment, UE, and further wherein the request comprises any one or more of: information about the UE, information about the ML inference process, and a request for information about a network to which the UE is connected. The method further comprises, after receiving the request, transmitting towards the UE split decision information indicating how to split the ML inference process.

In another aspect, there is provided a method performed by one or more network endpoints, NEs. The method comprises generating network endpoint (NE) information about said one or more NEs; transmitting towards an application function, AF, the generated NE information; and performing a first part of an ML inference process, wherein the ML inference process is split into the first part and a second part based at least on the NE information.

In another aspect, there is provided a method performed by a network data analytics function, a NWDAF. The method comprises receiving network endpoint, NE, information about one or more network endpoints, NEs, wherein the NE information was transmitted by an application function, AF. The method further comprises using at least the received NE information, generating analytic data for splitting a machine learning, ML, inference process; and transmitting towards the AF the generated analytic data.

In another aspect, there is provided a method performed by a network exposure function, NEF. The method comprises receiving a request for network endpoint (NE) information about one or more network endpoints, NEs, wherein the request for the NE information was transmitted by a network data analytics function, a NWDAF. The method further comprises receiving the NE information, wherein the NE information was transmitted by an application function, AF. The method further comprises, as a result of receiving the request for the NE information, forwarding the received NE information towards the NWDAF, wherein the NE information is used for determining how to split a machine learning, ML, inference process.

In another aspect, there is provided a computer program comprising instructions which when executed by processing circuitry cause the processing circuitry to perform the method of any one of embodiments described above.

In another aspect, there is provided a user equipment, UE. The UE is configured to transmit towards an application function, AF, a request for splitting an ML inference process, wherein the request comprises any one or more of: information about the UE, information about the ML inference process, and a request for information about a network to which the UE is connected; and after transmitting the request for splitting the ML inference process, receive split decision information indicating how to split the ML inference process, wherein the split decision information was transmitted by the AF.

In another aspect, there is provided an application function, AF. The AF is configured to receive a request for splitting an ML inference process, wherein the request was transmitted by a user equipment, UE, and further wherein the request comprises any one or more of: information about the UE, information about the ML inference process, and a request for information about a network to which the UE is connected; and after receiving the request, transmit towards the UE split decision information indicating how to split the ML inference process.

In another aspect, there is provided a network endpoint, NE. The NE is configured to generate network endpoint (NE) information about the NE; transmit towards an application function, AF, the generated NE information; and perform a first part of an ML inference process, wherein the ML inference process is split into the first part and a second part based at least on the NE information.

In another aspect, there is provided a network data analytics function, a NWDAF. The NWDAF is configured to receive network endpoint, NE, information about one or more network endpoints, NEs, wherein the NE information was transmitted by an application function, AF; using at least the received NE information, generate analytic data for splitting a machine learning, ML, inference process; and transmit towards the AF the generated analytic data.

In another aspect, there is provided a network exposure function, NEF. The NEF is configured to receive a request for network endpoint (NE) information about one or more network endpoints, NEs, wherein the request for the NE information was transmitted by a network data analytics function, a NWDAF; receive the NE information, wherein the NE information was transmitted by an application function, AF; as a result of receiving the request for the NE information, forward the received NE information towards the NWDAF, wherein the NE information is used for determining how to split a machine learning, ML, inference process.

In another aspect, there is provided an apparatus, the apparatus comprising: a memory; and processing circuitry coupled to the memory, wherein the apparatus is configured to perform the method of any one of embodiments described above.

Embodiments of this disclosure enable splitting an ML inference process among UEs and cloud/edge servers using various input data such as information about the ML inference process, information about UEs, and information about networks such that the ML inference process is optimally split.

### BRIEF DESCRIPTION OF THE DRAWINGS

The accompanying drawings, which are incorporated herein and form part of the specification, illustrate various embodiments.

FIG. 1A shows an exemplary scenario where embodiments of this disclosure are implemented.

FIG. 1B shows an example of input data of an ML model.

FIG. 1C shows an example of output data of an ML model.

FIG. 2 shows a cloud system according to some embodiments.

FIG. 3A shows an ML inference process.

FIG. 3B shows an exemplary way of splitting an ML inference process.

FIG. 4 shows a message flow diagram illustrating a message flow according to an embodiment.

FIG. 5 shows a process according to some embodiments.

FIG. 6 shows a process according to some embodiments.

FIG. 7 shows a process according to some embodiments.

FIG. 8 shows a process according to some embodiments.

FIG. 9 shows a process according to some embodiments.

FIG. 10 shows an apparatus according to some embodiments.

FIG. 11 shows an apparatus according to some embodiments.

### DETAILED DESCRIPTION

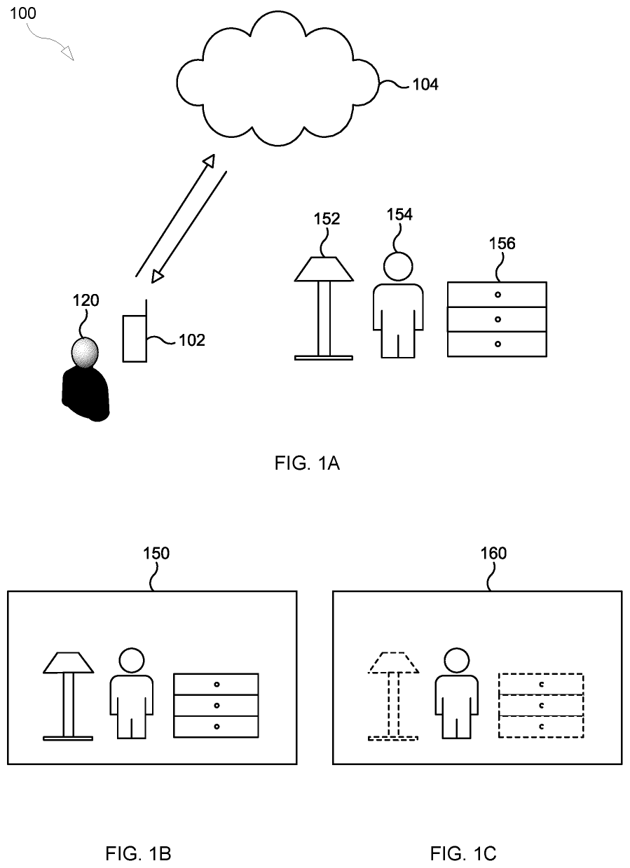

FIG. 1A shows an exemplary scenario 100 where embodiments of this disclosure are implemented. In the scenario 100, a user 120 captures an image 150 (shown in FIG. 1B) using camera(s) included in a user equipment (UE) 102. Here, UE 102 may be any computing device, including a mobile phone, a camera, a tablet, and a computer.

The captured image 150 includes a lamp 152, a human object 154, and a drawer 156. In some scenarios, user 120 may want to take a portrait picture of human object 154 in which all objects (e.g., lamp 152 and drawer 156) other than human object 154 are blurred. However, due to hardware limitation of the camera(s) included in UE 102, UE 102 may need to generate, based on the captured image 150, a portrait picture of human object 154 using software (i.e., using computational photography).

More specifically, once image 150 is captured, UE 102 may convert the captured image 150 (shown in FIG. 1B) into a portrait image 160 (shown in FIG. 1C) of human object 154 using a trained machine learning (ML) model. In this disclosure, an ML model or a trained ML model does not necessarily mean a single model, but it may be more than two models. As shown in FIG. 1C, in the portrait image 160, lamp 152 and drawer 156 (the objects that are not human object 154) are blurred.

In some scenarios, it may be desirable to run only a part of the ML model at UE 102 and run the rest of the ML model in a cloud system 104. For example, because of potential high power consumption at UE 102 in case UE 102 runs the entire ML model, it may be desirable to run at least some part of the ML model in cloud system 104. In another example, UE 102 may not just have enough computation power to run the entire ML model at UE 102.

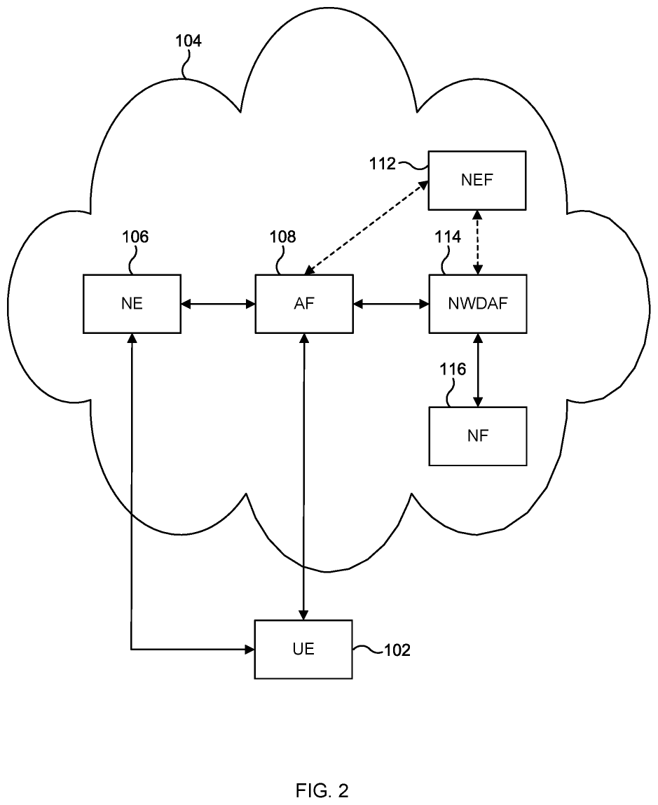

Accordingly, in some embodiments of this disclosure, at least a part of the ML model is run at UE 102 and the rest of the ML model is run at cloud system 104. As shown in FIG. 2, cloud system 104 may include any one or a combination of a base station (not shown), a network Al/ML endpoint (NE) (a cloud or edge server, or any other remote computing entity) 106, an application function (AF) 108, a network exposure function (NEF) 112, a network data analytics function (NWDAF) 114, and a network function (NF) 116. NE 106 is configured to run the rest of the ML model. The number of each of the entities (e.g., NE 106, AF 108, NEF 112, . . . ) shown in FIG. 2 is provided for illustration purpose only, and does not limit the embodiments of this disclosure in any way. For example, cloud system 114 may include more than one NE and/or more than one NWDAF.

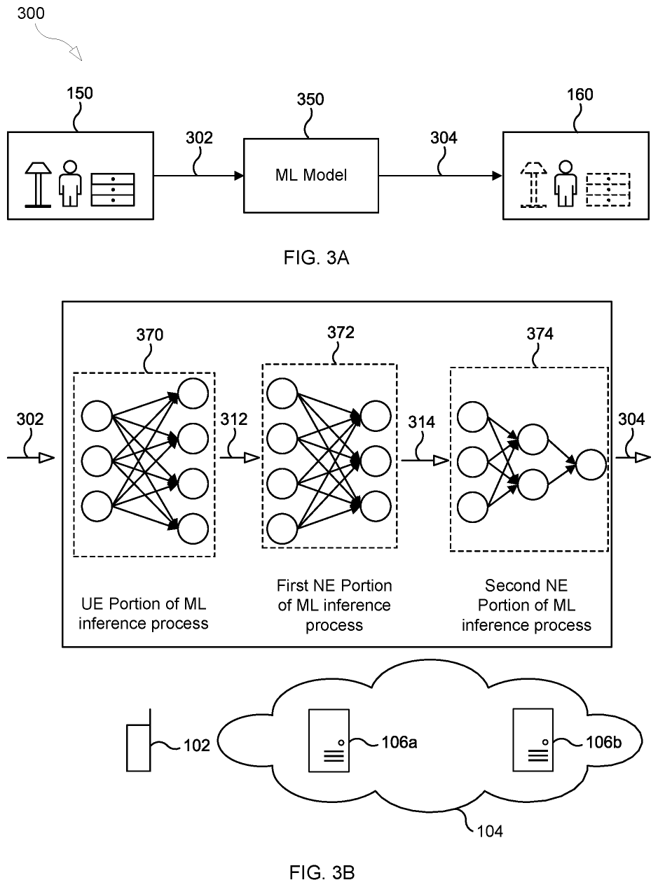

FIG. 3A shows a process 300 of running the ML model (a.k.a., performing “an ML inference process”). As shown in FIG. 3A, in this disclosure, running an ML model or performing an ML inference process means providing ML input data 302 to a trained ML model (herein after, “ML model”) 350, thereby generating ML output data 304. One example of performing an ML inference process is providing captured image 150 to ML model 350 which is configured to enhance (e.g., enhancing color, removing any red-eye, blurring non-focused objects etc.) captured image 150, and generate an enhanced image (e.g., the portrait image 160) based on captured image 150.

As discussed above, in some scenarios, it may be desirable to split ML inference process 300 into multiple parts, and to perform only a part of the ML inference process at UE 102 and the rest of ML inference process 300 in cloud system 104.

FIG. 3B shows an exemplary way of splitting ML inference process 300. In FIG. 3B, ML inference process 300 is split into three parts-UE portion of ML inference process 300, first NE portion of ML inference process 300, and second NE portion of ML inference process 300.

The UE portion of ML inference process 300 that is performed by UE 102 includes receiving ML input data 302 (e.g., the captured image 150) and generating first intermediate ML processed data 312 using a first portion 370 of the ML model 350 based on the received ML input data 302.

The first NE portion of ML inference process 300 that is performed by first NE 106a includes receiving the first intermediate ML processed data 312 and generating second intermediate ML processed data 314 using a second portion 372 of the ML model 350 based on the received first intermediate ML processed data 312.

The second NE portion of ML inference process 300 that is performed by second NE 106b includes receiving the second intermediate ML processed data 314 and generating ML output data 304 using a second portion 374 of the ML model 350 based on the received second intermediate ML processed data 314.

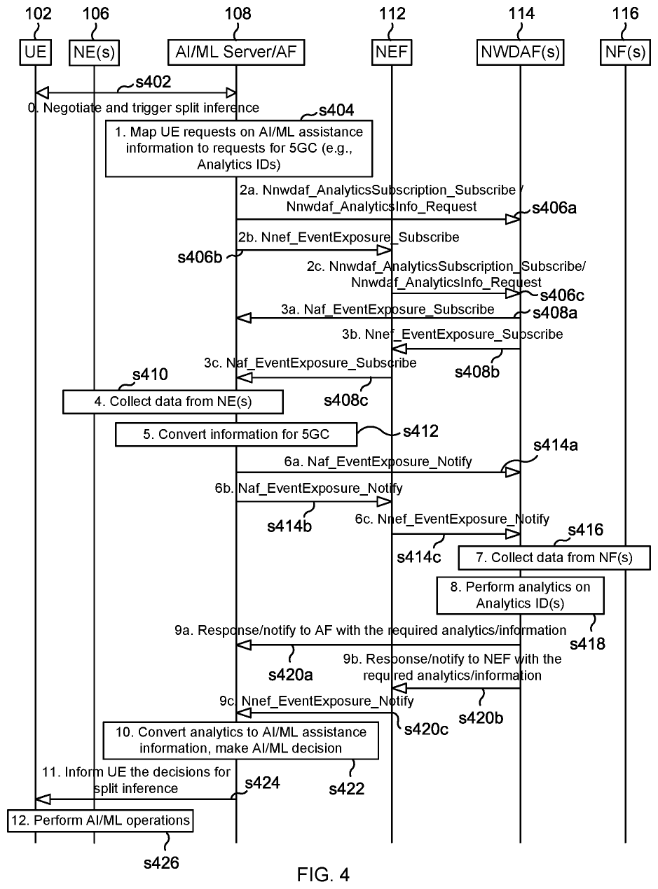

FIG. 4 shows a process 400 for splitting ML inference process 300 among different entities (e.g., UE 102 and NE), according to some embodiments. As shown in FIG. 4, process 400 involves interactions among UE 102, NE (e.g., cloud and edge servers) 106, AF 108, NWDAF 114, NF 116, and optionally NEF 112 in 5G Core (“5GC”). As explained above, the number of UE 102, NE 106, AF 108, NWDAF 114, NF 116, and/or NEF 112 shown in the figures is provided for illustration purpose only and does not limit the embodiments of this disclosure in any way.

Also, even though FIG. 4 shows that process 400 involves only one entity of each type, in some embodiments, process 400 may involve multiple entities of the same type. For example, in some embodiments, process 400 may involve multiple NEs 106, multiple NWDAFs 114, and/or multiple NFs 116. In such embodiments, the description of the operation of one NE is applicable to multiple NEs. Similarly, the description of the operation of one NWDAF is applicable to multiple NWDAFs and the description of the operation of one NF is applicable to multiple NFs.

In the embodiments of this disclosure, via the interactions among the different entities shown in FIG. 2, ML assistance information is generated, and based on the generated ML assistance information, ML inference process 300 can be split between UE 102 and NE 106.

As shown in FIG. 4, process 400 comprises a plurality of steps arranged in a particular order. However, the steps may not need to be performed in the order shown in FIG. 4, but may be performed in a different order. In other words, the order of steps shown in FIG. 4 is provided for simple explanation and does not limit the embodiments of this disclosure in any way.

Process 400 may begin with step s402. Step s402 comprises UE 102 transmitting towards AF 108 a request for splitting ML inference process 300. The request may be transmitted over the application layer. The request for splitting the ML inference process may include information about UE 102 and/or information about ML inference process 300.

The information about UE 102 may indicate a current location of UE 102 and/or information about one or more resources available at the UE. Examples of the one or more resources available at UE 102 include currently available computational capacity, remaining battery level, currently available communication capacity, etc.

The information about ML inference process 300 may indicate any one or more of: (1) one or more resource requirements for performing ML inference process 300 (e.g., the computational capacity required for performing ML inference process 300, the power consumption required for performing ML inference process 300, the required network bandwidth for performing ML inference process 300, etc.); (2) a size of intermediate output data (e.g., the size of intermediate ML processed data 312 or 314 shown in FIG. 3A) to be generated during ML inference process 300; (3) a time duration needed for performing ML inference process 300; or (4) an accuracy requirement of ML inference process 300.

The information about UE 102 and/or the information about ML inference process 300 may be used for determining how to split ML inference process 300. In one very simplified example, ML inference process 300 may be split depending on resource(s) available at UE 102 and resource requirements for performing ML inference process 300. More specifically, in such example, in case the computational complexity of ML inference process 300 is much higher than the computational capability of UE 102, most of ML inference process 300 may be performed at NE 106 and only a part of ML inference process 300 may be performed at UE 102.

In another very simplified example, ML inference process 300 may be split depending on whether the currently available network bandwidth for UE 102 can handle the transmission of certain intermediate ML processed data. More specifically, in case the size of intermediate ML processed data 312 is substantially greater than the size of intermediate ML processed data 314, and in case the currently available network bandwidth for UE 102 can only handle the size of intermediate ML processed data 314, ML inference process 300 may be split such that the parts of ML inference process 300 corresponding to ML layers 370 and 372 are performed at UE 102 while the part of ML inference process 300 corresponding to ML layer 374 is performed at NE 106.

In some embodiments, in addition to the information about UE 102 and the information about ML inference process 300, the request for splitting ML inference process 300 may also include a request for information about a network to which UE 102 is connected. The information about the network may indicate any one of more of a rate of uplink (UL) data transmission, a rate of downlink (DL) data transmission, a network latency, or a network reliability.

In case AF 108 provides to UE 102 multiple ways to split ML inference process 300, UE 102 may use this information (i.e., the information about the network to which UE 102 is connected) for selecting one of the multiple ways to use for splitting ML inference process 300. For example, in case the rate of UL data transmission is less than a threshold value, UE 102 may split ML inference process 300 such that the parts of ML inference process 300 corresponding to ML layers 370 and 372 are performed at UE 102, thereby configuring UE 102 to transmit intermediate ML processed data 314 instead of intermediate ML processed data 312 of which the size is greater than the size of intermediate output data 314.

Referring back to FIG. 4, after AF 108 receives the request for splitting ML inference process 300, AF 108 may optionally transmit to UE 102 an acknowledgement message acknowledging the receipt of the request.

In step s404, AF 108 may map the request to one or more analytic type identifiers (a.k.a., “analytics IDs”) identifying one or more types of analytics. In some embodiments, the analytics may correspond to standardized procedures for data measurement/collection and procedures for analyzing measured and/or collected data, such as DN performance, Observed Service Experience, Network Performance, NEs' Performance (possible new Analytics ID for NE's performance relevant analytics), etc. In such embodiments, the request may be mapped to a request for 5GC. One advantage of performing this mapping is that standardized message(s) or information element(s) defined in 5G may be used for exchanging data between the different entities. In some embodiments, instead of AF 108, NEF 112 (more specifically, an ML translator integrated in NEF 112) may perform this mapping.

After mapping the request for splitting ML inference process 300 to one or more analytics IDs, AF 108 may transmit towards NWDAF 114 a request for analytics data. The request for analytics data may be either a one-time request (i.e., a request for providing requested data once) or a subscription request (i.e., a request for providing requested data upon an occurrence of a certain event). The request for analytics data may include the one or more analytics IDs mapped in step s404 and/or the location of UE 102 included in the request for splitting ML inference process 300. The request for analytics data may also include additional input parameter(s) (e.g., one or more NE identifiers identifying one or more NEs). Examples of the NE identifier includes a data network access identifier (DNAI), an IP address, and/or a fully qualified domain name (FQDN).

The method of transmitting the request for analytics data from AF 108 to NWDAF 114 may vary depending on whether AF 108 is in the trusted domain or not.

In case AF 108 is in the trusted domain, AF 108 may interact with NF(s) (e.g., NWDAF 114) in 5GC directly. More specifically, in case AF 108 is in the trusted domain, step s406a may be performed. In step s406a, AF 108 transmits the request for analytics data to NWDAF 114. Examples of the request for analytics data include an Nnwdaf_AnalyticsSubscription_Subscribe service operation message and/or an Nnwdaf_AnalyticsInfo_Request service operation message, which are described in 3GPP TS 23.288.

On the other hand, in case AF 108 is in the untrusted domain, AF 108 may interact with NF(s) in 5GC via NEF 112. More specifically, in case AF 108 is in the untrusted domain, steps 406b and 406c may be performed instead of step s406a. In step s406b, AF 108 transmits a first request for analytics data to NEF 112 (e.g., a request for event exposure of analytics data), and in step s406c, NEF 112 transmits a second request for analytics data to NWDAF 114. An example of the first request for analytics data transmitted by AF 108 to NEF 112 is an Nnef_EventExposure_Subscribe service operation message (described in 3GPP TS 23.288) and examples of the second request for analytics data transmitted by NEF 112 to NWDAF 114 are an Nnwdaf_AnalyticsSubscription_Subscribe service operation message and/or an Nnwdaf_AnalyticsInfo_Request service operation message (described in 3GPP TS 23.288).

In some embodiments, NWDAF 114 may transmit towards AF 108 a request for network AI/ML endpoint (NE) information. The request may be an event exposure subscription request or may be a one-time request. In some embodiments, NWDAF 114 may transmit the request for NE information as a result of receiving the request for analytics data discussed with respect to steps s406a-s406c above. The requested NE information may include any one or more of: an amount of computational resources available at NE 106 or end-to-end network performance (e.g., latency, throughput, packet loss rate, etc.) between one or more pairs of NEs in two adjacent layers (in case there is more than one layer(s) of NE(s)).

In some embodiments, the request for NE information is for particular NE(s). In such embodiments, NWDAF 114 may select one or more NEs for which NE information is requested. There are different ways of selecting the one or more NEs. For example, NWDAF 114 may select one or more NEs that satisfy any one or more of: (1) the amount of available resource of a NE is higher than threshold amount(s) or (2) (if more than two layers), the end-to-end latency between a pair of NEs in two adjacent layers is lower than threshold value(s).

The threshold(s) for computation resource and latency may be decided by AF 108 or based on a negotiation between UE 102 and AF 108.

The method of transmitting the request for NE information from NWDAF 114 to AF 108 may vary depending on whether AF 108 is in the trusted domain or not.

In case AF 108 is in the trusted domain, AF 108 may interact with NF(s) (e.g., NWDAF 114) in 5GC directly. More specifically, in case AF 108 is in the trusted domain, step s408a may be performed. In step s408a, NWDAF 114 transmits the request for NE information to AF 108. One example of the request for NE information is an Naf_EventExposure_Subscribe service operation message for subscribing NWDAF 114 to event exposure from AF 108. The service operation message is described in 3GPP TS 23.288.

On the other hand, in case AF 108 is in the untrusted domain, AF 108 may interact with NF(s) in 5GC via NEF 112. More specifically, in case AF 108 is in the untrusted domain, steps 408b and 408c may be performed instead of step s408a. In step s408b, NWDAF 114 transmits a first request for NE information to NEF 112, and in step s408c, NEF 112 transmits a second request for NE information to AF 108. An example of the first request for NE information transmitted by NWDAF 114 to NEF 112 is an Nnef_EventExposure_Subscribe service operation message for subscribing NWDAF 114 to event exposure from NEF 112 and an example of the second request for NE information transmitted by NEF 112 to AF 108 is an Naf_EventExposure_Subscribe service operation message for subscribing NEF 112 to event exposure from AF 108. The service operation messages are described in 3GPP TS 23.288.

In step s410, AF 108 may collect NE information from NE 106. The NE information may include any one or more of: an amount of computational resources available at NE 106 or end-to-end network performance (e.g., latency, throughput, packet loss rate, etc.) between one or more pairs of NEs in two adjacent layers (in case there is more than one layer(s) of NE(s). Additionally, the NE information may include user experience data indicating observed user experience for splitting an ML inference process. This user experience data may indicate, for example, one or more user's satisfaction of previously using an application ran by a ML inference process that are split.

In some embodiments, AF 108 collects the NE information from NE 106 periodically. However, in other embodiments, AF 108 collects the NE information from NE 106 as a result of receiving the request for NE information, which was transmitted by NWDAF 114.

After performing step s410, an optional step s412 may be performed. Step s412 comprises AF 108 converting the collected NE information into information for 5GC. Like step s404, one purpose of this conversion is to use an existing standardized 5G message (or information element (IE)) to carry the collected NE information.

After collecting the NE information or converting the collected NE information, AF 108 may transmit towards NWDAF 114 the collected NE information or the converted NE information.

Like the request for NE information, the method of transmitting the collected NE information or the converted NE information from AF 108 to NWDAF 114 may vary depending on whether AF 108 is in the trusted domain or not.

In case AF 108 is in the trusted domain, step s414a may be performed. In step s414a, AF 108 transmits the collected NE information or the converted NE information to NWDAF 114. One example of the service operation message to use for transmission of the NE information or the converted NE information is an Naf_EventExposure_Notify service operation message, which is described in 3GPP TS 23.288.

On the other hand, in case AF 108 is in the untrusted domain, steps 414b and 414c may be performed instead of step s414a. In step s414b, AF 108 transmits the collected NE information or the converted NE information to NEF 112 and in step 414c, NEF 112 transmits the collected NE information or the converted NE information NWDAF 114. One example of the service operation message to use for transmission of the NE information or the converted NE information from AF 108 to NEF 112 is an Naf_EventExposure_Notify service operation message and one example of the message to use for transmission of the NE information or the converted NE information from NEF 112 to NWDAF 114 is an Nnef_EventExposure_Notify service operation message. The messages are described in 3GPP TS 23.288.

In step s416, NWDAF 114 may collect data from one or more network functions (NF(s)). The type of data collected in step s416 may depend on the analytics IDs mapped in step s404 and requested in steps 406a or 406b and 406c. For example, the data collected in step s416 may correspond to DN performance (e.g., QoS flow identifier (QFI), QoS flow bit rate, QoS flow packet delay, etc.), Observed Service Experience, Network Performance, or NEs Performance (possible new Analytics ID for ENs performance relevant analytics), etc.

In step s418, NWDAF 114 may generate analytics data based on the NE information transmitted by AF 108 and the data collected from NF(s). In some embodiments, a ML model stored in NWDAF 114 may be used to generate analytics data. More specifically, the NE information and the data collected from NF(s) may be provided to the ML model stored in NWDAF 114, and the ML model may generate the analytics data based on those input information.

The generated analytics data may include any one or more of: (1) historical statistics and/or predictions regarding uplink, UL, data transmission from a user equipment, UE, to each of said one or more NEs; (2) historical statistics and/or predictions regarding packet delay on UL data transmission from the UE to each of said one or more NEs; (3) historical statistics and/or predictions regarding packet loss rate on UL data transmission from the UE to each of said one or more NEs; (4) a quality of service (QoS) indicator indicating a predicted quality of service in case the ML inference process is split; (5) or statistics/predictions about communication performance between NEs.

After generating the analytics data in step s418, NWDAF 114 may transmit towards AF 108 the generated analytics data.

The method of transmitting the generated analytics data from NWDAF 114 to AF 108 may vary depending on whether AF 108 is in the trusted domain or not.

In case AF 108 is in the trusted domain, step s420a may be performed. In step s420a, NWDAF 114 transmits the generated analytics data to AF 108. One example of the message used for transmitting the generated analytics data is an Nnwdaf_AnalyticsSubscription_Notify service operation message and/or an Nnwdaf_AnalyticsInfo_Request response.

On the other hand, in case AF 108 is in the untrusted domain, steps 420b and 420c may be performed instead of step s420a. In step s420b, NWDAF 114 transmits the generated analytics data to NEF 112, and in step s420c, NEF 112 transmits the generated analytics data to AF 108. One example of the message used for transmitting the generated analytics data from NWDAF 114 to NEF 112 is an Nnwdaf AnalyticsSubscription_Notify service operation message and/or an Nnwdaf_AnalyticsInfo_Request response and one example of the message used for transmitting the generated analytics data from NEF 112 to AF 108 is an Nnef_EventExposure_Notify service operation message.

After receiving the analytics data, in step s422, AF 108 may generate ML assistance information based on the received analytics data and may make a decision regarding how to split ML inference process 300 based on the ML assistance information and/or the information about UE 102 obtained in step s402 (e.g., a current location of UE 102 and/or information about one or more resources available at the UE). In some embodiments, the conversion of the analytics data into the ML assistance information may occur at NEF 112 instead of AF 108.

In some embodiments, AF 108 may obtain multiple analytics data. In such embodiment, AF 108 may combine the obtained multiple analytics data, and the ML assistance information may be generated based on the combination of the multiple analytics data. For example, the ML assistance information may include historical statistics and/or predictions regarding a network condition (e.g., network latency, bitrate, communication service availability, network reliability, etc.).

The decision made by AF 108 may indicate any one or more of: (1) a number of ML layers for performing a part of the ML inference process at UE 102; (2) one or more NE identifiers identifying one or more NEs to perform a part of the ML inference process; (3) an ML layer identifier identifying an ML layer of which an operation corresponds to the last operation performed by the UE for the ML inference process; (4) an ML layer identifier identifying an ML layer of which an operation corresponds to the last operation performed by one of said one or more NEs; or (5) a time period for performing a part of the ML inference process at the UE.

In case there are multiple NEs 106, AF 108 may need to select from the multiple NEs one or more NEs for performing a part of ML inference process 300. In some embodiments, the selection of the one or more NEs may be made randomly. However, in other embodiments, the selection of the one or more NEs may be made based on the ML assistance information.

After making the decision as to how to split ML inference process 300, in step s424, AF 106 transmits towards UE 102 split decision information indicating how to split the ML operation and/or which ML sub-operations included in the ML operation UE 102 should perform. The transmission of the split decision information may occur over the application layer. For example, in case the ML operation includes a first ML sub-operation, a second ML sub-operation, and a third ML sub-operation, the split decision information may indicate that UE 102 should perform the first ML sub-operation and the second ML sub-operation.

More specifically, as shown in FIG. 3, in case the ML operation is performed by three ML sub-operations performed by three layers 370, 372, and 374, the split decision information may indicate that UE 102 should perform the ML sub-operations of the first two layers 370 and 372. The transmission of the split decision from AF 106 to UE 102 may occur over application layer.

As discussed above, in case there are multiple NEs 106, AF 108 may select from the multiple NEs one or more NEs for performing a part of ML inference process 300. In such embodiments, in step s424, AF 106 may also transmit towards UE 102 NE identifier(s) (e.g., a data network access identifier (DNAI), an IP address, and/or a fully qualified domain name (FQDN)) identifying the selected one or more NEs.

Upon receiving the split decision information, in step s426, UE 102 performs a part of ML inference process 300, thereby generating intermediate ML processed output data (e.g., 312 or 314). After performing the part of ML inference process 300, UE 102 may transmit towards NE 106 the generated intermediate ML processed output data (e.g., 312 or 314). After receiving the intermediate ML processed output data, NE 106 may perform the remaining part of ML inference process 300, thereby generating the final ML processed output data (e.g., 304).

In some embodiments, the whole ML model for performing ML inference process 300 may be stored in NE 106 prior to step s426. In such embodiments, in step s426, UE 102 only need to transmit to NE 106 an indication indicating which part of ML inference process 300 NE 106 needs to perform. However, in other embodiments, the ML model may not be stored in NE 106. In such embodiments, in step s426, UE 102 may transmit to NE 106 not only the indication indicating which part of ML inference process 300 NE 106 needs to perform but also the part of the ML model for performing the indicated part of ML inference process 300.

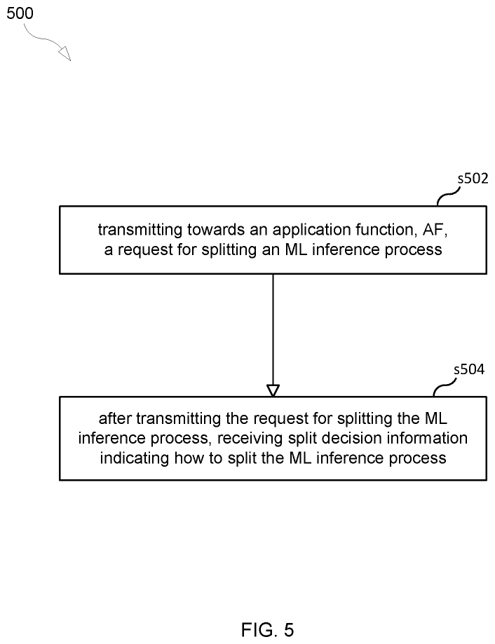

FIG. 5 shows a process 500 performed by UE 102 according to some embodiments. Process 500 may begin with step s502. Step s502 comprises transmitting towards an application function, AF, a request for splitting an ML inference process, wherein the request comprises any one or more of: information about the UE, information about the ML inference process, and a request for information about a network to which the UE is connected. Step s504 comprises after transmitting the request for splitting the ML inference process, receiving (s504) split decision information indicating how to split the ML inference process, wherein the split decision information was transmitted by the AF.

In some embodiments, the information about the UE indicates a location of the UE and/or information about one or more resources available at the UE. The information about the ML inference process indicates any one or more of: one or more requirements on resources needed for performing the ML inference process; a size of intermediate output data to be generated during the ML inference process; a time duration needed for performing the ML inference process; or an accuracy requirement of the ML inference process. The information about the network indicates any one of more of a rate of uplink (UL) data transmission, a rate of downlink (DL) data transmission, a network latency, or a network reliability.

In some embodiments, the method further comprises based on the received split decision information, selecting a part of the ML inference process; and performing the selected part of the ML inference process.

In some embodiments, the method further comprises transmitting towards one or more network points (NEs) ML sub-process data indicating a part of the ML inference process to be performed by said one or more NEs.

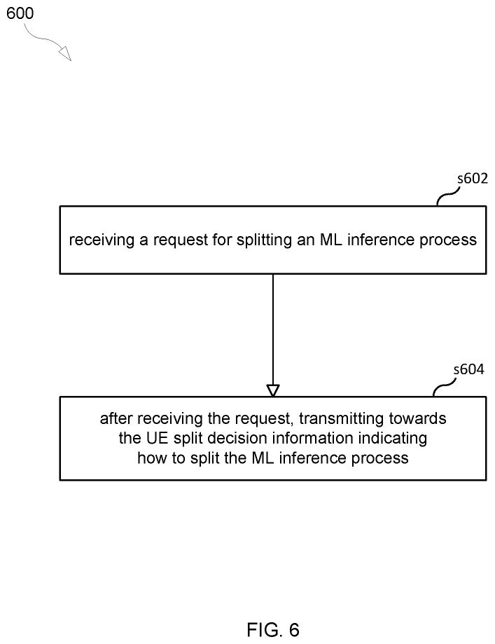

FIG. 6 shows a process 600 performed by AF 108 according to some embodiments. Process 600 may begin with step s602. Step s602 comprises receiving a request for splitting an ML inference process, wherein the request was transmitted by a user equipment, UE, and further wherein the request comprises any one or more of: information about the UE, information about the ML inference process, and a request for information about a network to which the UE is connected. Steps 604 comprises after receiving the request, transmitting towards the UE split decision information indicating how to split the ML inference process.

In some embodiments, the information about the UE indicates a location of the UE and/or information about one or more resources available at the UE. The information about the ML inference process indicates any one or more of: one or more requirements on resources needed for performing the ML inference process; a size of intermediate output data to be generated during the ML inference process; a time duration needed for performing the ML inference process; or an accuracy requirement of the ML inference process. The information about the network indicates any one of more of a rate of uplink (UL) data transmission, a rate of downlink (DL) data transmission, a network latency, or a network reliability.

In some embodiments, the method further comprises mapping the request for splitting an ML inference process to one or more analytic type identifiers identifying one or more types of analytics.

In some embodiments, the method further comprises receiving network endpoint, NE, information about one or more network endpoints, NEs, wherein the NE information was transmitted by said one or more NEs.

In some embodiments, the NE information indicates any one or more of: an amount of computational resources available at said one or more NEs, and end-to-end network performance between one or more pairs of NEs in case said one or more NEs includes more than one NE.

In some embodiments, the method further comprises transmitting towards a network data analytics function, a NWDAF, data indicating the NE information.

In some embodiments, the data indicating the NE information is transmitted as a result of the NWDAF subscribing to the AF for the data or transmitting to the AF a request for the data.

In some embodiments, subscribing to the AF for the data or transmitting to the AF the request for the data comprises the AF receiving a Naf_EventExposure_Subscribe message, wherein the Naf_EventExposure_Subscribe message was transmitted by the NWDAF or a network exposure function, NEF.

In some embodiments, the method further comprises receiving analytic data of said one or more types identified by said one or more analytic type identifiers, wherein the analytic data is generated based on the NE information.

In some embodiments, the method further comprises subscribing to the NWDAF for the analytic data or transmitting to the NWDAF a request for the analytic data, wherein the analytic data is received at the AF as a result of the subscription or the transmission of the request to the NWDAF.

In some embodiments, subscribing to the NWDAF for the analytic data or transmitting the request to the NWDAF for the analytic data comprises: the AF transmitting towards the NWDAF a Nnwdaf_AnalyticsSubscription_Subscribe message or a Nnwdaf_AnalyticsInfo_Request message, or the AF triggering a network exposure function, NEF, to transmit towards the NWDAF a Nnwdaf_AnalyticsSubscription_Subscribe message or a Nnwdaf_AnalyticsInfo_Request message.

In some embodiments, the analytic data indicates any one or more of: historical statistics and/or predictions regarding UL data transmission from the UE to each of said one or more NEs; historical statistics and/or predictions regarding packet delay on UL data transmission from the UE to each of said one or more NEs; historical statistics and/or predictions regarding packet loss rate on UL data transmission from the UE to each of said one or more NEs; or a quality of service (QoS) indicator indicating a predicted quality of service in case the ML inference process is split.

In some embodiments, the method further comprises determining how to split the ML inference process based on the received analytic data, wherein determining how to split the ML inference process comprises determining any one or more of: a number of ML layers for performing a part of the ML inference process at the UE; one or more NE identifiers identifying said one or more NEs to perform a part of the ML inference process; an ML layer identifier identifying an ML layer of which an operation corresponds to the last operation performed by the UE for the ML inference process; an ML layer identifier identifying an ML layer of which an operation corresponds to the last operation performed by one of said one or more NEs; or a time period for performing a part of the ML inference process at the UE.

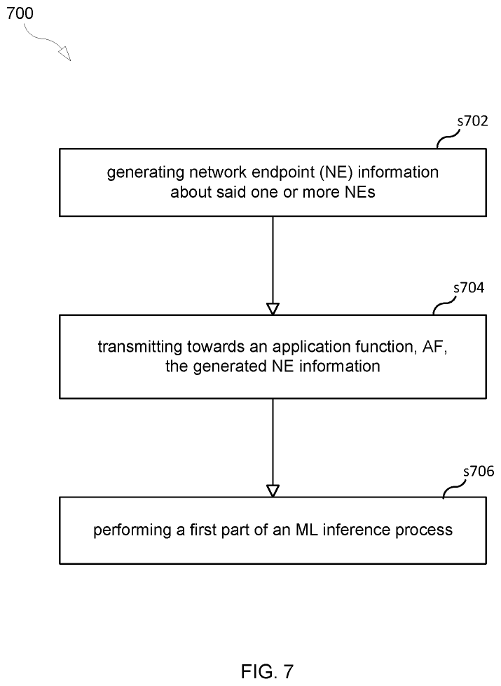

FIG. 7 shows a process 700 performed by NE 106 according to some embodiments. Process 700 may begin with step s702. Step s702 comprises generating network endpoint (NE) information about said one or more NEs. Step s704 comprises transmitting towards an application function, AF, the generated NE information. Step s706 comprises performing a first part of an ML inference process, wherein the ML inference process is split into the first part and a second part based at least on the NE information.

In some embodiments, the NE information indicates any one or more of: an amount of computational resources available at said one or more NEs, and end-to-end network performance between one or more pairs of NEs in case said one or more NEs includes more than one NE.

In some embodiments, the method further comprises receiving ML sub-process data indicating the first part of the ML inference process, wherein the ML sub-process data was transmitted by a user equipment, UE.

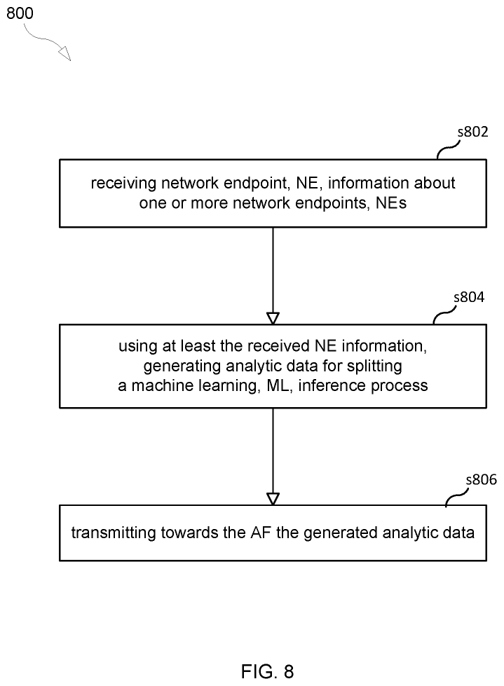

FIG. 8 shows a process 800 performed by NWDAF 114 according to some embodiments. Process 800 may begin with step s802. Step s802 comprises receiving network endpoint, NE, information about one or more network endpoints, NEs, wherein the NE information was transmitted by an application function, AF. Step s804 comprises using at least the received NE information, generating analytic data for splitting a machine learning, ML, inference process. Step s806 comprises transmitting towards the AF the generated analytic data.

In some embodiments, the analytic data for splitting the ML inference process indicates any one or more of: historical statistics and/or predictions regarding uplink, UL, data transmission from a user equipment, UE, to each of said one or more NEs; historical statistics and/or predictions regarding packet delay on UL data transmission from the UE to each of said one or more NEs; historical statistics and/or predictions regarding packet loss rate on UL data transmission from the UE to each of said one or more NEs; or a quality of service (QOS) indicator indicating a predicted quality of service in case the ML inference process is split.

In some embodiments, the NE information indicates any one or more of: an amount of computational resources available at said one or more NEs, and end-to-end network performance between one or more pairs of NEs in case said one or more NEs includes more than one NE.

In some embodiments, the method comprises subscribing to the AF for the NE information or transmitting to the AF a request for the NE information, wherein the NE information is received at the NWDAF as a result of the subscription or the transmission of the request to the AF.

In some embodiments, subscribing to the AF for the NE information or transmitting to the AF the request for the NE information comprises (1) the NWDAF transmitting towards the AF an Naf_EventExposure_Subscribe message or (2) the NWDAF transmitting towards a network exposure function, NEF an Nnef_EventExposure_Subscribe message, and the NEF transmitting towards the AF an Naf_EventExposure_Subscribe message.

In some embodiments, the analytic data is transmitted as a result of the AF subscribing to the NWDAF for the analytic data or transmitting a request towards the NWDAF a request for the analytic data.

In some embodiments, subscribing to the NWDAF for the analytic data or transmitting the request to the NWDAF for the analytic data comprises the NWDAF receiving a Nnwdaf_AnalyticsSubscription_Subscribe message or a Nnwdaf_AnalyticsInfo_Request message, which was transmitted by the AF or was triggered to be transmitted by a network exposure function, NEF, by the AF.

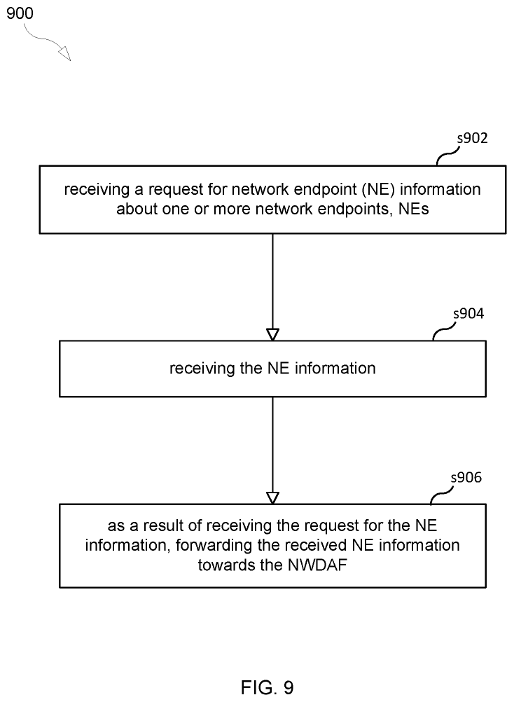

FIG. 9 shows a process 900 performed by NEF 112 according to some embodiments. Process 900 may begin with step s902. Step s902 comprises receiving a request for network endpoint (NE) information about one or more network endpoints, NEs, wherein the request for the NE information was transmitted by a network data analytics function, a NWDAF. Step s904 comprises receiving the NE information, wherein the NE information was transmitted by an application function, AF. Step s906 comprises as a result of receiving the request for the NE information, forwarding (s906) the received NE information towards the NWDAF, wherein the NE information is used for determining how to split a machine learning, ML, inference process.

In some embodiments, the NE information indicates any one or more of: an amount of computational resources available at said one or more NEs, and end-to-end network performance between one or more pairs of NEs in case said one or more NEs includes more than one NE.

In some embodiments, the request for the NE information is a Naf_EventExposure_Subscribe message.

In some embodiments, the method further comprises receiving a request for analytic data for splitting a machine learning, ML, inference process, wherein the request for the analytic data was transmitted by the AF; receiving the analytic data, wherein the analytic data was transmitted by the NWDAF; and as a result of receiving the request for the analytic data, forwarding the received analytic data towards the AF.

In some embodiments, the request for the analytic data is a Nnwdaf_AnalyticsSubscription_Subscribe message or a Nnwdaf_AnalyticsInfo_Request message.

In some embodiments, the analytic data for splitting the ML inference process indicates any one or more of: historical statistics and/or predictions regarding uplink, UL, data transmission from a user equipment, UE, to each of said one or more NEs; historical statistics and/or predictions regarding packet delay on UL data transmission from the UE to each of said one or more NEs; historical statistics and/or predictions regarding packet loss rate on UL data transmission from the UE to each of said one or more NEs; or a quality of service (QoS) indicator indicating a predicted quality of service in case the ML inference process is split.

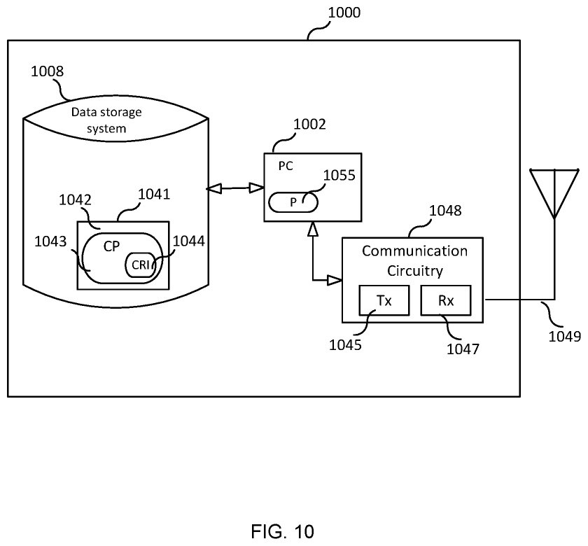

FIG. 10 is a block diagram of UE 102, according to some embodiments. As shown in FIG. 10, UE 102 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like); communication circuitry 1048, which is coupled to an antenna arrangement 1049 comprising one or more antennas and which comprises a transmitter (Tx) 1045 and a receiver (Rx) 1047 for enabling UE 102 to transmit data and receive data (e.g., wirelessly transmit/receive data); and a local storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1,041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes UE 102 to perform steps described herein (e.g., steps described herein with reference to the flow charts). In other embodiments, UE 102 may be configured to perform steps described herein without the need for code. That is, for example, PC 1002 may consist merely of one or more ASICs. Hence, the features of the embodiments described herein may be implemented in hardware and/or software.

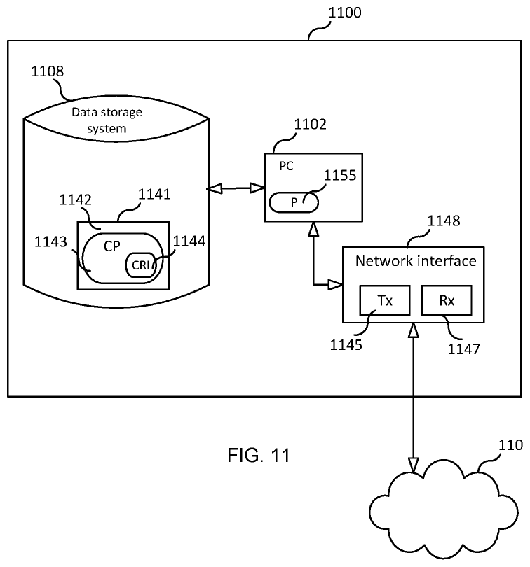

FIG. 11 is a block diagram of an apparatus 1100, according to some embodiments, for implementing any of NE 106, AF 108, NEF 112, NWDAF 114, and NF 116. As shown in FIG. 11, apparatus 1100 may comprise: processing circuitry (PC) 1102, which may include one or more processors (P) 1155 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1100 may be a distributed computing apparatus); a network interface 1148 comprising a transmitter (Tx) 1145 and a receiver (Rx) 1147 for enabling apparatus 1100 to transmit data to and receive data from other nodes connected to a network 110 (e.g., an Internet Protocol (IP) network) to which network interface 1148 is connected (directly or indirectly) (e.g., network interface 1148 may be wirelessly connected to the network 110, in which case network interface 1148 is connected to an antenna arrangement); and a local storage unit (a.k.a., “data storage system”) 1108, which may include one or more non-volatile storage devices and/or one or more volatile storage devices. In embodiments where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes apparatus 1100 to perform steps described herein (e.g., steps described herein with reference to the flow charts). In other embodiments, apparatus 1100 may be configured to perform steps described herein without the need for code. That is, for example, PC 1102 may consist merely of one or more ASICs. Hence, the features of the embodiments described herein may be implemented in hardware and/or software.

### Summary of Embodiments

A1. A method (500) performed by a user equipment, UE (102), the method comprising:
transmitting (s502) towards an application function, AF, a request for splitting an ML inference process, wherein the request comprises any one or more of: information about the UE, information about the ML inference process, and a request for information about a network to which the UE is connected; and
after transmitting the request for splitting the ML inference process, receiving (s504) split decision information indicating how to split the ML inference process, wherein
the split decision information was transmitted by the AF.

A2. The method of embodiment A1, wherein
the information about the UE indicates a location of the UE and/or information about one or more resources available at the UE,
the information about the ML inference process indicates any one or more of:
   i) one or more requirements on resources needed for performing the ML inference process;
   ii) a size of intermediate output data to be generated during the ML inference process;
   iii) a time duration needed for performing the ML inference process; or
   iv) an accuracy requirement of the ML inference process, and
the information about the network indicates any one or more of: a rate of uplink (UL) data transmission, a rate of downlink (DL) data transmission, a network latency, and/or a network reliability.

A3. The method of embodiment A1 or A2, the method further comprising:
based on the received split decision information, selecting a part of the ML inference process; and
performing the selected part of the ML inference process.

A4. The method of any one of embodiments A1-A3, further comprising:
transmitting towards one or more network endpoints (NEs) ML sub-process data indicating a part of the ML inference process to be performed by said one or more NEs.

B1. A method (600) performed by an application function, AF (108), the method comprising:
receiving (s602) a request for splitting an ML inference process, wherein the request was transmitted by a user equipment, UE, and further wherein the request comprises any one or more of: information about the UE, information about the ML inference process, and a request for information about a network to which the UE is connected; and
after receiving the request, transmitting (s604) towards the UE split decision information indicating how to split the ML inference process.

B2. The method of embodiment B1, wherein
the information about the UE indicates a location of the UE and/or information about one or more resources available at the UE,
the information about the ML inference process indicates any one or more of:
   i) one or more requirements on resources needed for performing the ML inference process;
   ii) a size of intermediate output data to be generated during the ML inference process;
   iii) a time duration needed for performing the ML inference process; or
   iv) an accuracy requirement of the ML inference process, and
the information about the network indicates any one or more of: a rate of uplink (UL) data transmission, a rate of downlink (DL) data transmission, a network latency, and/or a network reliability.

B3. The method of embodiment B1 or B2, further comprising mapping the request for splitting an ML inference process to one or more analytic type identifiers identifying one or more types of analytics.

B4. The method of any one of embodiments B1-B3, further comprising:
receiving network endpoint, NE, information about one or more network endpoints, NEs, wherein
the NE information was transmitted by said one or more NEs.

B5. The method of embodiment B4, wherein the NE information indicates any one or more of:
an amount of computational resources available at said one or more NEs, and/or
end-to-end network performance between one or more pairs of NEs in case said one or more NEs includes more than one NE.

B6. The method of embodiment B4 or B5, further comprising transmitting towards a network data analytics function, a NWDAF, data indicating the NE information.

B6a. The method of embodiment B6, wherein the data indicating the NE information is transmitted as a result of the NWDAF subscribing to the AF for the data or transmitting to the AF a request for the data.

B6b. The method of embodiment B6a, wherein subscribing to the AF for the data or transmitting to the AF the request for the data comprises the AF receiving a Naf_EventExposure_Subscribe message, wherein
the Naf_EventExposure_Subscribe message was transmitted by the NWDAF or a network exposure function, NEF.

B7. The method of any one of embodiments B3-B6b, further comprising receiving analytic data of said one or more types identified by said one or more analytic type identifiers, wherein
the analytic data is generated based on the NE information.

B7a. The method of embodiment B7, comprising subscribing to the NWDAF for the analytic data or transmitting to the NWDAF a request for the analytic data, wherein the analytic data is received at the AF as a result of the subscription or the transmission of the request to the NWDAF.

B7b. The method of embodiment B7a, wherein subscribing to the NWDAF for the analytic data or transmitting the request to the NWDAF for the analytic data comprises:
the AF transmitting towards the NWDAF a Nnwdaf_AnalyticsSubscription_Subscribe message or a Nnwdaf_AnalyticsInfo_Request message, or
the AF triggering a network exposure function, NEF, to transmit towards the NWDAF a Nnwdaf_AnalyticsSubscription_Subscribe message or a Nnwdaf_AnalyticsInfo_Request message.

B8. The method of any one of embodiments B7-B7b, wherein the analytic data indicates any one or more of:
historical statistics and/or predictions regarding UL data transmission from the UE to each of said one or more NEs;
historical statistics and/or predictions regarding packet delay on UL data transmission from the UE to each of said one or more NEs;
historical statistics and/or predictions regarding packet loss rate on UL data transmission from the UE to each of said one or more NEs; or
a quality of service (QOS) indicator indicating a predicted quality of service in case the ML inference process is split.

B9. The method of any one of embodiments B7-B8, further comprising determining how to split the ML inference process based on the received analytic data, wherein determining how to split the ML inference process comprises determining any one or more of:
a number of ML layers for performing a part of the ML inference process at the UE;
one or more NE identifiers identifying said one or more NEs to perform a part of the ML inference process;
an ML layer identifier identifying an ML layer of which an operation corresponds to the last operation performed by the UE for the ML inference process;
an ML layer identifier identifying an ML layer of which an operation corresponds to the last operation performed by one of said one or more NEs; or
a time period for performing a part of the ML inference process at the UE.

C1. A method (700) performed by one or more network endpoints, NEs (106), the method comprising:
generating (s702) network endpoint (NE) information about said one or more NEs;
transmitting (s704) towards an application function, AF, the generated NE information; and
performing (s706) a first part of an ML inference process, wherein
the ML inference process is split into the first part and a second part based at least on the NE information.

C2. The method of embodiment C1, wherein the NE information indicates any one or more of:
an amount of computational resources available at said one or more NEs, and
end-to-end network performance between one or more pairs of NEs in case said one or more NEs includes more than one NE.

C3. The method of embodiment C1 or C2, further comprising:
receiving ML sub-process data indicating the first part of the ML inference process, wherein the ML sub-process data was transmitted by a user equipment, UE.

D1. A method (800) performed by a network data analytics function, a NWDAF (114), the method comprising:
receiving (s802) network endpoint, NE, information about one or more network endpoints, NEs, wherein the NE information was transmitted by an application function, AF;
using at least the received NE information, generating (s804) analytic data for splitting a machine learning, ML, inference process; and
transmitting (s806) towards the AF the generated analytic data.

D2. The method of embodiment D1, wherein the analytic data for splitting the ML inference process indicates any one or more of:
historical statistics and/or predictions regarding uplink, UL, data transmission from a user equipment, UE, to each of said one or more NEs;
historical statistics and/or predictions regarding packet delay on UL data transmission from the UE to each of said one or more NEs;
historical statistics and/or predictions regarding packet loss rate on UL data transmission from the UE to each of said one or more NEs; or
a quality of service (QOS) indicator indicating a predicted quality of service in case the ML inference process is split.

D3. The method of embodiment D1 or D2, wherein the NE information indicates any one or more of:
an amount of computational resources available at said one or more NEs, and
end-to-end network performance between one or more pairs of NEs in case said one or more NEs includes more than one NE.

D4. The method of any one of embodiments D1-D3, the method comprising subscribing to the AF for the NE information or transmitting to the AF a request for the NE information, wherein the NE information is received at the NWDAF as a result of the subscription or the transmission of the request to the AF.

D5. The method of embodiment D4, wherein subscribing to the AF for the NE information or transmitting to the AF the request for the NE information comprises the NWDAF transmitting towards the AF an Naf_EventExposure_Subscribe message.

D6. The method of any one of embodiments D1-D5, wherein the analytic data is transmitted as a result of the AF subscribing to the NWDAF for the analytic data or transmitting a request towards the NWDAF a request for the analytic data.

D7. The method of embodiment D6, wherein subscribing to the NWDAF for the analytic data or transmitting the request to the NWDAF for the analytic data comprises:
the NWDAF receiving a Nnwdaf_AnalyticsSubscription_Subscribe message or a Nnwdaf_AnalyticsInfo_Request message, which was transmitted by the AF or was triggered to be transmitted by a network exposure function, NEF, by the AF.

E1. A method (900) performed by a network exposure function, NEF (112), the method comprising:
receiving (s902) a request for network endpoint (NE) information about one or more network endpoints, NEs, wherein the request for the NE information was transmitted by a network data analytics function, a NWDAF;
receiving (s904) the NE information, wherein the NE information was transmitted by an application function, AF; and
as a result of receiving the request for the NE information, forwarding (s906) the received NE information towards the NWDAF, wherein
the NE information is used for determining how to split a machine learning, ML, inference process.

E2. The method of embodiment E1, wherein the NE information indicates any one or more of:
an amount of computational resources available at said one or more NEs, and
end-to-end network performance between one or more pairs of NEs in case said one or more NEs includes more than one NE.

E3. The method of embodiment E1 or E2, wherein the request for the NE information is a Naf_EventExposure_Subscribe message or a Nnef_EventExposure_Subscribe message.

E4. The method of any one of embodiments E1-E3, further comprising:
receiving a request for analytic data for splitting a machine learning, ML, inference process, wherein the request for the analytic data was transmitted by the AF;
receiving the analytic data, wherein the analytic data was transmitted by the NWDAF; and
as a result of receiving the request for the analytic data, forwarding the received analytic data towards the AF.

E5. The method of embodiment E4, wherein the request for the analytic data is a Nnwdaf_AnalyticsSubscription_Subscribe message or a Nnwdaf_AnalyticsInfo_Request message.

E6. The method of embodiment E4 or E5, wherein the analytic data for splitting the ML inference process indicates any one or more of:
historical statistics and/or predictions regarding uplink, UL, data transmission from a user equipment, UE, to each of said one or more NEs;
historical statistics and/or predictions regarding packet delay on UL data transmission from the UE to each of said one or more NEs;
historical statistics and/or predictions regarding packet loss rate on UL data transmission from the UE to each of said one or more NEs; or
a quality of service (QoS) indicator indicating a predicted quality of service in case the ML inference process is split.

F1. A computer program (1043 or 1143) comprising instructions (1044 or 1144) which when executed by processing circuitry (1002 or 1102) cause the processing circuitry to perform the method of any one of embodiments A1-E6.

F2. A carrier containing the computer program of embodiment F1, wherein the carrier is one of an electronic signal, an optical signal, a radio signal, and a computer readable storage medium.

G1. A user equipment, UE (102), the UE being configured to:
transmit (s502) towards an application function, AF, a request for splitting an ML inference process, wherein the request comprises any one or more of: information about the UE, information about the ML inference process, and/or a request for information about a network to which the UE is connected; and
after transmitting the request for splitting the ML inference process, receive (s504) split decision information indicating how to split the ML inference process, wherein
the split decision information was transmitted by the AF

G2. The UE of embodiment G1, wherein the UE is further configured to perform the method of any one of embodiments A2-A4.

H1. An application function, AF (108), the AF being configured to:
receive (s602) a request for splitting an ML inference process, wherein the request was transmitted by a user equipment, UE, and further wherein the request comprises any one or more of: information about the UE, information about the ML inference process, and a request for information about a network to which the UE is connected; and
after receiving the request, transmit (s604) towards the UE split decision information indicating how to split the ML inference process.

H2. The AF of embodiment H1, wherein the AF is further configured to perform the method of any one of embodiments B2-B9.

I1. A network endpoint, NE (106), the NE being configured to:
generate (s702) network endpoint (NE) information about the NE;
transmit (s704) towards an application function, AF, the generated NE information; and
perform (s706) a first part of an ML inference process, wherein
the ML inference process is split into the first part and a second part based at least on the NE information.

I2. The NE of embodiment I1, wherein the NE is further configured to perform the method of any one of embodiments C2-C3.

J1. A network data analytics function, a NWDAF (114), the NWDAF being configured to:
receive (s802) network endpoint, NE, information about one or more network endpoints, NEs, wherein the NE information was transmitted by an application function, AF;
using at least the received NE information, generate (s804) analytic data for splitting a machine learning, ML, inference process; and
transmit (s806) towards the AF the generated analytic data.

J2. The NWDAF of embodiment J1, wherein the NWDAF is further configured to perform the method of any one of embodiments E2-E7.

K1. A network exposure function, NEF (112), the NEF being configured to:
receive (s902) a request for network endpoint (NE) information about one or more network endpoints, NEs, wherein the request for the NE information was transmitted by a network data analytics function, a NWDAF;
receive (s904) the NE information, wherein the NE information was transmitted by an application function, AF;
as a result of receiving the request for the NE information, forward (s906) the received NE information towards the NWDAF, wherein
the NE information is used for determining how to split a machine learning, ML, inference process.

K2. The NEF of embodiment K1, wherein the NEF is further configured to perform the method of any one of embodiments E2-E6.

L1. An apparatus (1000 or 1100), the apparatus comprising:
a memory (1041 or 1141); and
processing circuitry (1002 or 1102) coupled to the memory, wherein the apparatus is configured to perform the method of any one of embodiments A1-E6.

### Conclusion

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method (500) performed by a user equipment (UE), the method comprising:
transmitting towards an application function (AF) a request for splitting a machine learning (ML) inference process, wherein the request comprises any one or more of: information about the UE, information about the ML inference process, and/or a request for information about a network to which the UE is connected; and
after transmitting the request for splitting the ML inference process, receiving split decision information indicating how to split the ML inference process, wherein
the split decision information was transmitted by the AF.

2. The method of claim 1, wherein
the information about the UE indicates a location of the UE and/or information about one or more resources available at the UE,
the information about the ML inference process indicates:
i) one or more requirements on resources needed for performing the ML inference process;
ii) a size of intermediate output data to be generated during the ML inference process;
iii) a time duration needed for performing the ML inference process; and/or
iv) an accuracy requirement of the ML inference process, and t
he information about the network indicates any one or more of: a rate of uplink (UL) data transmission, a rate of downlink (DL) data transmission, a network latency, and/or a network reliability.

3. The method of claim 1, the method further comprising:
based on the received split decision information, selecting a part of the ML inference process; and
performing the selected part of the ML inference process.

4. The method of claim 1, further comprising:
transmitting towards one or more network end points (NEs) ML sub-process data indicating a part of the ML inference process to be performed by said one or more NEs.

5. A method performed by an application function (AF), the method comprising:
receiving a request for splitting a machine learning (ML) inference process, wherein the request was transmitted by a user equipment (UE), and further wherein the request comprises: information about the UE, information about the ML inference process, and/or a request for information about a network to which the UE is connected; and
after receiving the request, transmitting towards the UE split decision information indicating how to split the ML inference process.

6. The method of claim 5, wherein
the information about the UE indicates a location of the UE and/or information about one or more resources available at the UE,
the information about the ML inference process indicates:
i) one or more requirements on resources needed for performing the ML inference process;
ii) a size of intermediate output data to be generated during the ML inference process;
iii) a time duration needed for performing the ML inference process; and/or
iv) an accuracy requirement of the ML inference process, and
the information about the network indicates any one or more of a rate of uplink (UL) data transmission, a rate of downlink (DL) data transmission, a network latency, or a network reliability.

7. The method of claim 5, further comprising mapping the request for splitting an ML inference process to one or more analytic type identifiers identifying one or more types of analytics.

8. The method of claim 5, further comprising:
receiving network endpoint, NE, information about one or more network endpoints (Nes), wherein
the NE information was transmitted by said one or more NEs.

9. The method of claim 8, wherein the NE information indicates:
an amount of computational resources available at said one or more NEs, and/or
end-to-end network performance between one or more pairs of NEs in case said one or more NEs includes more than one NE.

10. The method of claim 8, further comprising transmitting towards a network data analytics function (NWDAF) data indicating the NE information.

11. The method of claim 10, wherein the data indicating the NE information is transmitted as a result of the NWDAF subscribing to the AF for the data or transmitting to the AF a request for the data.

12. (canceled)

13. The method of claim 7, further comprising receiving analytic data of said one or more types identified by said one or more analytic type identifiers, wherein
the analytic data is generated based on the NE information.

14-15. (canceled)

16. The method of claim 13, wherein the analytic data indicates:
historical statistics and/or predictions regarding UL data transmission from the UE to each of said one or more NEs;
historical statistics and/or predictions regarding packet delay on UL data transmission from the UE to each of said one or more NEs;
historical statistics and/or predictions regarding packet loss rate on UL data transmission from the UE to each of said one or more NEs; and/or
a quality of service (QoS) indicator indicating a predicted quality of service in case the ML inference process is split.

17. The method of claim 13, further comprising determining how to split the ML inference process based on the received analytic data, wherein determining how to split the ML inference process comprises determining:
a number of ML layers for performing a part of the ML inference process at the UE;
one or more NE identifiers identifying said one or more NEs to perform a part of the ML inference process;
an ML layer identifier identifying an ML layer of which an operation corresponds to the last operation performed by the UE for the ML inference process;
an ML layer identifier identifying an ML layer of which an operation corresponds to the last operation performed by one of said one or more NEs; and/or a time period for performing a part of the ML inference process at the UE.

18. A method performed by one or more network endpoints, the method comprising:
generating network endpoint (NE) information about said one or more NEs;
transmitting towards an application function, AF, the generated NE information; and
performing a first part of an ML inference process, wherein
the ML inference process is split into the first part and a second part based at least on the NE information.

19. The method of claim 18, wherein the NE information indicates:
an amount of computational resources available at said one or more NEs, and/or
end-to-end network performance between one or more pairs of NEs in case said one or more NEs includes more than one NE.

20. The method of claim 18, further comprising:
receiving ML sub-process data indicating the first part of the ML inference process, wherein the ML sub-process data was transmitted by a user equipment, UE.

21. A method performed by a network data analytics function, (NWDAF), the method comprising:
receiving network endpoint (NE) information about one or more NEs, wherein the NE information was transmitted by an application function (AF);
using at least the received NE information, generating analytic data for splitting a machine learning (ML) inference process; and
transmitting towards the AF the generated analytic data.

22. The method of claim 21, wherein the analytic data for splitting the ML inference process indicates:
historical statistics and/or predictions regarding uplink, UL, data transmission from a user equipment, UE, to each of said one or more NEs;
historical statistics and/or predictions regarding packet delay on UL data transmission from the UE to each of said one or more NEs;
historical statistics and/or predictions regarding packet loss rate on UL data transmission from the UE to each of said one or more NEs; and/or
a quality of service (QoS) indicator indicating a predicted quality of service in case the ML inference process is split.

23. The method of claim 21, wherein the NE information indicates:
an amount of computational resources available at said one or more NEs, and/or
end-to-end network performance between one or more pairs of NEs in case said one or more NEs includes more than one NE.

24-46. (canceled)
